(19) United States
(12) Patent Application Publication
(10) Pub. No.: US 2013/0185322 A1
(43) Pub. Date: Jul. 18, 2013

(54) SYSTEMS AND METHODS FOR PROVIDING AN ELECTRONIC CONTACT CARD

(71) Applicant: Aaron James Vegh, Whitby (CA)

(72) Inventor: Aaron James Vegh, Whitby (CA)

(21) Appl. No.: 13/348,928

(22) Filed: Jan. 12, 2012

(51) Int. Cl. G06F 17/30

(52) U.S. Cl. 707/769; 707/E17.014

(57) ABSTRACT

Systems and methods for providing an electronic contact card are shown, and specifically, systems and methods for providing an electronic contact card in a format compatible with electronic contact books associated with computing devices.

### TECHNICAL FIELD

The described embodiments relate to systems and methods for providing an electronic contact card, and specifically, to systems and methods for providing an electronic contact card in a format compatible with electronic contact books associated with computing devices.

### BACKGROUND

Electronic contact cards, such as electronic business cards, which are also known as internet or virtual contact cards, or “vCards”, may be used to share personal or business contact information.

The contact information for electronic contact cards may be electronically updated and accessed. Given the widespread use of computing devices, electronic contact cards may be more convenient than traditional physical business cards. A recipient of an electronic contact card may not need to manually convert the information into an electronic format since the electronic contact cards may be directly stored into the address books associated with the computing devices. Some types of computing devices may not compatible with some electronic contact card formats.

### SUMMARY

In a first aspect, embodiments described herein may provide a method for providing an electronic contact card comprising: storing a plurality of electronic contact card records, wherein each electronic contact card record comprises contact data associated with an entity; routing a dynamic uniform resource locator of a web browser to a controller file, wherein the uniform resource locator comprises a record identifier and a source value, wherein the record identifier corresponds to an electronic contact card record and wherein the source value corresponds to an electronic contact card format; parsing the dynamic uniform resource locator to provide the record identifier and the source value as parameters to a routing rule of the controller file; generating a specific resource using a script program of the controller file, wherein the routing rule passes the record identifier and the source value to the script program to generate the specific resource, and wherein the specific resource is for accessing an electronic contact card, wherein the electronic contact card is generated using at least a portion of the contact data of the electronic contact card record identified by the record identifier and is in the electronic contact card format corresponding to the source value.

In accordance with some embodiments, the new static uniform resource locator may be activated to stream the electronic contact card to the web browser.

In accordance with some embodiments, prior to routing the uniform resource locator of the web browser to the controller file, the method may comprise: receiving a request to generate the electronic contact card, wherein the request comprises the record identifier and the source value; generating the uniform resource locator using the record identifier and the source value.

In accordance with some embodiments, the method may further comprise: retrieving the corresponding electronic contact card record using the record identifier; using the source value to determine the electronic contact card format, wherein the format is compatible with an electronic contact book; generating the electronic contact card in the format compatible with the electronic contact book, wherein the electronic contact card comprises the portion of contact data of the corresponding electronic business record; and associating the new static uniform resource locator with the electronic contact card.

In another aspect, embodiments described herein may provide a system for providing an electronic contact card comprising: a record database comprising a plurality of electronic contact card records, wherein each electronic contact card record comprises contact data associated with an entity; a format database for storing a plurality of electronic contact card formats compatible with a corresponding plurality of electronic contact books; a record identifier matrix for associating each of the plurality of electronic contact card records with a corresponding record identifier; a format matrix for associating each of the electronic contact card formats with a corresponding source value; a script processor comprising a controller file, wherein the controller file comprises at least a routing rule and a script program; a routing mechanism for routing a uniform resource locator of a web browser to the controller file, wherein the uniform resource locator comprises a record identifier and a source value, wherein the record identifier corresponds to an electronic contact card record and wherein the source value corresponds to an electronic contact card format; wherein the routing rule receives the source value and the record identifier and passes the source value and the record identifier to the script program for generating a specific resource, wherein the specific resource is for accessing an electronic contact card, wherein the electronic contact card is generated using at least a portion of the contact data of the electronic contact card record and is in the electronic contact card format corresponding to the source value.

### BRIEF DESCRIPTION OF THE DRAWINGS

For a better understanding of embodiments of the systems and methods described herein, and to show more clearly how they may be carried into effect, reference will be made, by way of example, to the accompanying drawings in which:

FIG. 1 illustrates example uniform resource locator addresses in accordance with an example embodiment;

FIG. 2 is a block diagram of components interacting with an electronic contact card system in accordance with an example embodiment;

FIG. 3 is a block diagram of an electronic contact card system in accordance with an example embodiment;

FIG. 4 is a block diagram of a controller file in accordance with an example embodiment;

FIG. 5 is a flowchart diagram of a method for providing an electronic contact card in accordance with an example embodiment.

The drawings, described below, are provided for purposes of illustration, and not of limitation, of the aspects and features of various examples of embodiments described herein. The drawings are not intended to limit the scope of the teachings in any way. For simplicity and clarity of illustration, elements shown in the figures have not necessarily been drawn to scale. The dimensions of some of the elements may be exaggerated relative to other elements for clarity. Further, where considered appropriate, reference numerals may be repeated among the figures to indicate corresponding or analogous elements.

### DETAILED DESCRIPTION

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example, a suitable programmable computer may be a server, network appliance, set-top box, embedded device, computer expansion module, personal computer, laptop, personal data assistant, mobile device or any other computing device capable of being configured to carry out the methods described herein. Program code is applied to input data to perform the functions described herein and to generate output information. The output information is applied to one or more output devices, in known fashion. In some embodiments, the communication interface may be a network communication interface. In embodiments in which elements of the invention are combined, the communication interface may be a software communication interface, such as those for inter-process communication (IPC). In still other embodiments, there may be a combination of communication interfaces implemented as hardware, software, and combination thereof.

Each program may be implemented in a high level procedural or object oriented programming or scripting language, or both, to communicate with a computer system. For example, a program may be written in XML, HTML 5, and so on. However, alternatively the programs may be implemented in assembly or machine language, if desired. The language may be a compiled or interpreted language. Each such computer program may be stored on a storage media or a device (e.g. ROM, magnetic disk, optical disc), readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product including a physical non-transitory computer readable medium that bears computer usable instructions for one or more processors. The medium may be provided in various forms, including one or more diskettes, compact disks, tapes, chips, magnetic and electronic storage media, and the like. The computer useable instructions may also be in various forms, including compiled and non-compiled code.

Systems and methods described herein may provide electronic contact cards, and specifically, provide electronic contact cards in a format compatible with address books associated with different types of computing devices. Electronic contact cards, such as electronic business cards, may also be referred to as internet or virtual contact cards, or “vCards”. Like traditional physical contact cards, electronic contact cards are a means for conveying information, such as names, photo(s), credential(s), title(s), phone number(s), email address(es), links to website(s), links to social network profile(s), chat instant message handle(s), audio clips, video clips, URLS, photographs, images, logos, and so on. The electronic contact card may include personal information, business information, or a combination thereof. The information on business cards may generally be customized.

Electronic contact cards may be easily shared with others. For example, instead of requiring an exchange of physical cards in order to share information, an individual or business may share an electronic contact card by sharing a uniform resource locator (URL) address associated with the electronic contact card or a file of the electronic contact card via a messaging service, website or other data sharing technique. The content of electronic contact cards may be updated and those updates may be propagated to others. For example, a database may store records for electronic contact cards, where each record is associated with an electronic contact card and stores and manages the content of the associated electronic contact card. A user may update the content of the electronic contact card by updating the record for that electronic contact card in the database. When a request for the electronic contact card is received then the updated contents of the record stored in the database may be provided in response to the request. The database may implement versioning and maintain previous content that has been updated as a previous version of the electronic contact card.

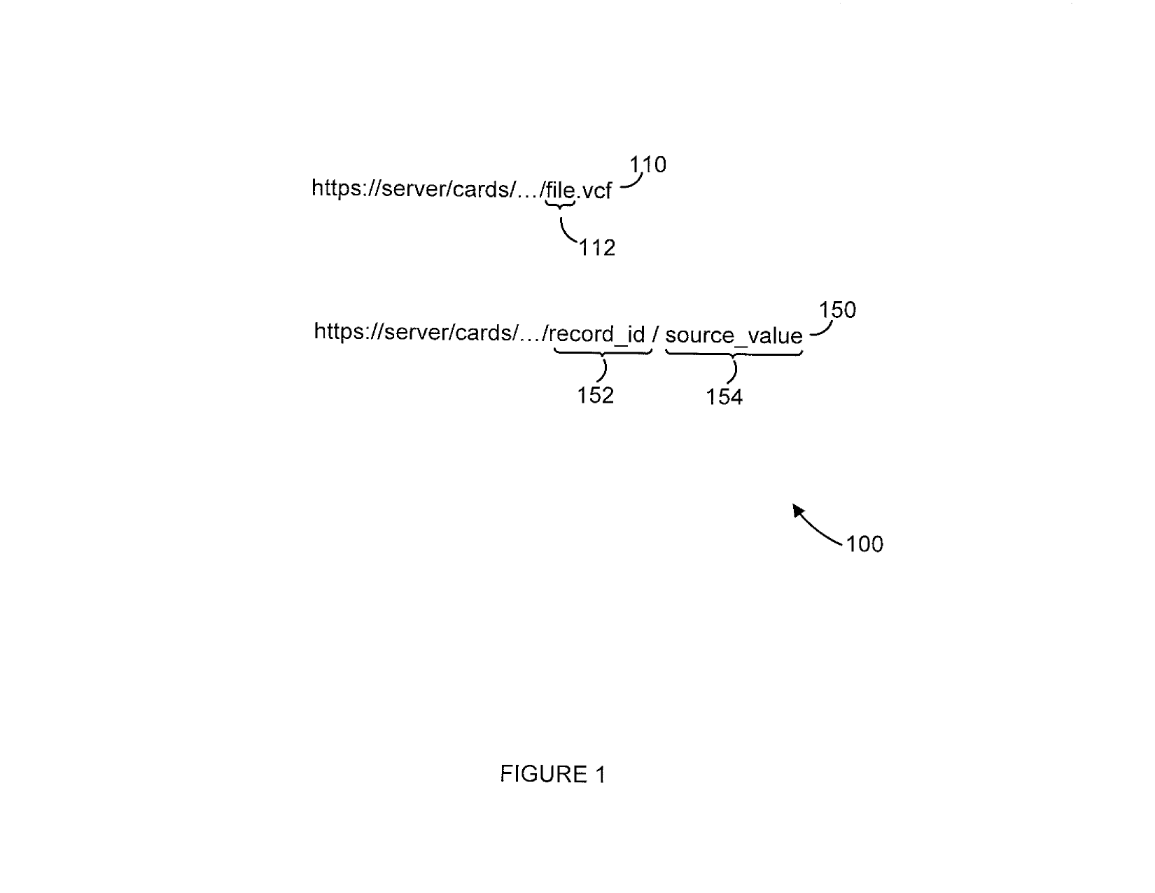

Reference is now made to FIG. 1, which illustrates example URL addresses 100 in accordance with an example embodiment.

A URL address may be associated with a static file URL address 110, where a static file (e.g. an electronic contact card file) may be stored on a server for access by users. A static file URL address associated with an electronic contact card is typically in the vCard file format with a “.vcf” file path or extension, but may be in other suitable file formats. The static file URL address 110 may include various parameters, such as, for example, a file reference (“file”) 112 for associating the static file URL address 110 with a file for a particular electronic contact card. When this static file URL address 110 is activated on a web browser, a command may be sent to a server for the electronic contact card associated with the file reference 112 to be streamed or otherwise transmitted to the web browser. The electronic contact card file being streamed may contain header information that identifies its file type so that the web browser may identify the file as an electronic contact card and know how to handle the file accordingly.

Alternatively, a URL address may instead be associated with a dynamic URL address 150 for an electronic contact card. The dynamic URL address 150 may include various parameters associated with a file or record storing the contents for the electronic contact card on a server accessed using the dynamic URL address 150. Parameters may be associated with values or content stored in the record, formatting information and so on in order to dynamically generate a particular electronic contact card. The parameters may include a record identifier (“record_id”) 152 for identifying the record associated with the electronic contact card being generated and a source value (“source_value”) 154 for identifying an electronic contact card format compatible with an electronic contact book on a device for which the business card is intended to be transmitted to. Other parameters may not be parsed or extracted from the dynamic URL address 150. For example, parameters that relate to environment factors may be used to determine the format of the card. For example, the type of web browser may be detected so that the electronic contact card may be formatted specific to the type of web browser. These parameters may not be passed in the dynamic URL address 150 and instead may be gleaned from the headers sent by the web browser.

When the dynamic URL address 150 is accessed through a web browser, a corresponding electronic contact card is generated based on the parameters provided in the dynamic URL address 150. The electronic contact card may be stored on a web server. In other embodiments, the electronic contact card may be streamed to the web browser and not stored or cached by a web server. The electronic contact card may not be stored on the web server because of the dynamic requirements of varying the format and contents of the electronic contact card, based on for example, the source, electronic contact book, and computing device. A command may be sent to the web server for the electronic contact card file generated from the dynamic URL address 150 to be streamed to the web browser. Like the static file associated with the static file URL address 110 described above, the file associated with the dynamic URL address 150 may contain, at least, header information that identifies its file type as an electronic contact card so that the web browser may identify the file as an electronic contact card and know to handle the file accordingly.

Web browsers on some computing devices, such as a BlackBerry™ device for example, may not recognize a file generated using a dynamic URL address 150 as a file associated with an electronic contact card unless it is a static file or static URL with “.vcf” file path or extension. For example, some web browsers may only recognize URL addresses ending in “.vcf” as being associated with an electronic contact card because the web browsers consider only file paths and not the header information inside a file identifying the file type as being an electronic contact card. As a result, these web browsers may be unable to handle electronic contact cards associated with dynamic URL addresses 150. The systems and methods described herein provide an electronic contact card generated using a dynamic URL address 150 in a format recognizable as being an electronic contact card by a web browser and computing device that may typically only handle static files with “.vcf” file path or extension. Further, some web browsers on some computing devices, such as a BlackBerry device for example, may otherwise not be compatible with dynamic URL addresses 150 for electronic contact cards and some electronic contact card formats. The systems and methods described herein provide an electronic contact card that may be provided in a format compatible with a variety of web browsers, address books, and computing devices.

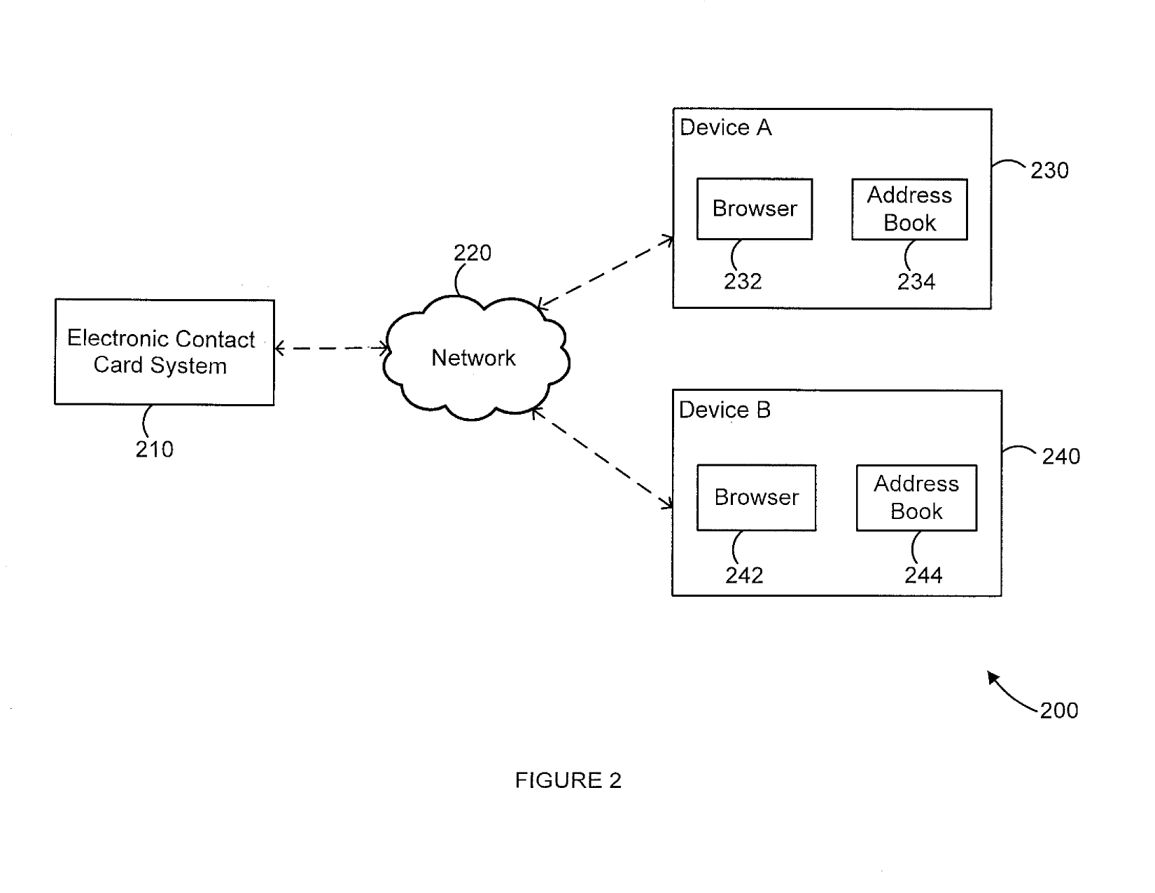

Reference is now made to FIG. 2, which illustrates a block diagram of components 200 interacting with an electronic contact card system 210 over a network 220 in accordance with an example embodiment.

The electronic contact card system 210 may be a server system that has one or more processors with computing processing abilities and memory such as a database(s) or file system(s). Although only one electronic contact card system 210 is shown for clarity, there may be multiple one electronic contact card system 210 distributed over a wide geographic area and connected via e.g. network 220.

The electronic contact card system 210 may have a network interface for connecting to the network 220, for example, in order to communicate with other components, to serve web pages, to provide electronic contact card and other computing applications. Specifically, the electronic contact card system 210 and various computing devices, such as, for example, Device A 230 and/or Device B 240, may each have a network interface for connecting to the network 220 in order to communicate with each other and/or other components.

The electronic contact card system 210 is operable to receive requests for generating electronic contact cards from various computing devices, such as devices 230 and/or 240, over the network 220. It will be understood that the electronic contact card system 210 may be operable to communicate with one or more computing devices, and that the illustrated embodiment is merely an example and other configurations may be used.

Each of the devices 230 and 240 may be any networked computing device associated with one or more web browsers, such as browser 232 or 242 for example, and an electronic contact book, address book 234 or 244 for example. The electronic contact book manages electronic contact cards and stores the electronic contact cards in memory. A networked device is a device capable of communicating with other devices through a communication network such as the network 220. A network device may couple to the communication network 220 through a wired or wireless connection.

Devices 230 and 240 include at least a processor and memory, and may be an electronic tablet device, a personal computer, workstation, server, portable computer, mobile device, personal digital assistant, laptop, smart phone, WAP phone, an interactive television, video display terminals, gaming consoles, and portable electronic devices or a combination of these.

Devices 230 and 240 may be the same type or different types of devices and have a different set of components and configurations. For example, the device 230 may be a mobile device, such as a Blackberry™ device, and the device 240 may be an electronic tablet device. In an alternative example, both the devices 230 and 40 may be mobile devices. Although two devices 230 and 240 are shown there may be more or less computing devices interacting with the electronic contact card system 210.

Each device 230 or 240 may be associated with one or more types of web browsers 232 and 242. Each of the web browsers 232 or 242 on each respective device 230 or 240 may be of the same or different type of web browsers. There may be one or multiple web browsers 232, 242 on device 230, 240. The web browsers 232 and 242 may be capable of communicating with the network 220.

Further, devices 230 and 240 may be associated with an electronic contact book, for example address book 234 or 244, respectively. The electronic address books 234 and 244 manage and store electronic contact cards and their contact information, such as names, photo(s), credential(s), title(s), phone number(s), email address(es), links to website(s), links to social network profile(s), chat and instant message handle(s), etc. The contact information may be manually entered into the electronic contact books 234 or 244 and/or imported directly from electronic contact cards.

The network 220 may be any network(s) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

A dynamic URL address 150 associated with an electronic contact card may be routed or directed from a web browser, such as web browser 232 or 242, to the electronic contact card system 210 via the network 220.

In accordance with some embodiments, prior to routing the URL address associated with the dynamic electronic contact card 150 to the electronic contact card system 210, a request to generate an electronic contact card may be sent from a computing device, such as device 230 or 240. The request may include or correspond to various parameters, including a record identifier 152 and a source value 154, from which the dynamic URL address 150 for the electronic contact card may be generated.

The dynamic URL address 150 may contain various parameters, including the record identifier 152 and the source value 154. The record identifier 152 may be associated with an electronic contact card record selected from electronic contact card records stored in a database. The record identifier may identify the record storing the contents for the electronic contact card. Each electronic contact card record may contain contact data information associated with an entity. The source value 154 may identify a format for the electronic contact card, the destination the electronic contact card is intended for, a recipient for the electronic contact card and so on. The source value 154 may be associated with an electronic contact card format compatible with an electronic contact book, such as address book 234 or 244, on a device, such as devices 230 or 240 respectively.

When the dynamic URL address 150 is routed from a web browser, such as browser 232 or 242, to the electronic contact card system 210, various parameters in the dynamic URL address 150, such as the record identifier 152 and the source value 154, may be provided to the electronic contact card system 210 when the dynamic URL address 150 is provided to the electronic contact card system 210. The electronic contact card system 210 parses the dynamic URL address 150 and uses a script program to generate a specific resource for accessing an electronic contact card. The electronic contact card accessed using the specific resource comprises data in the electronic contact card record associated with the record identifier 152 and formatted based on the source value 154.

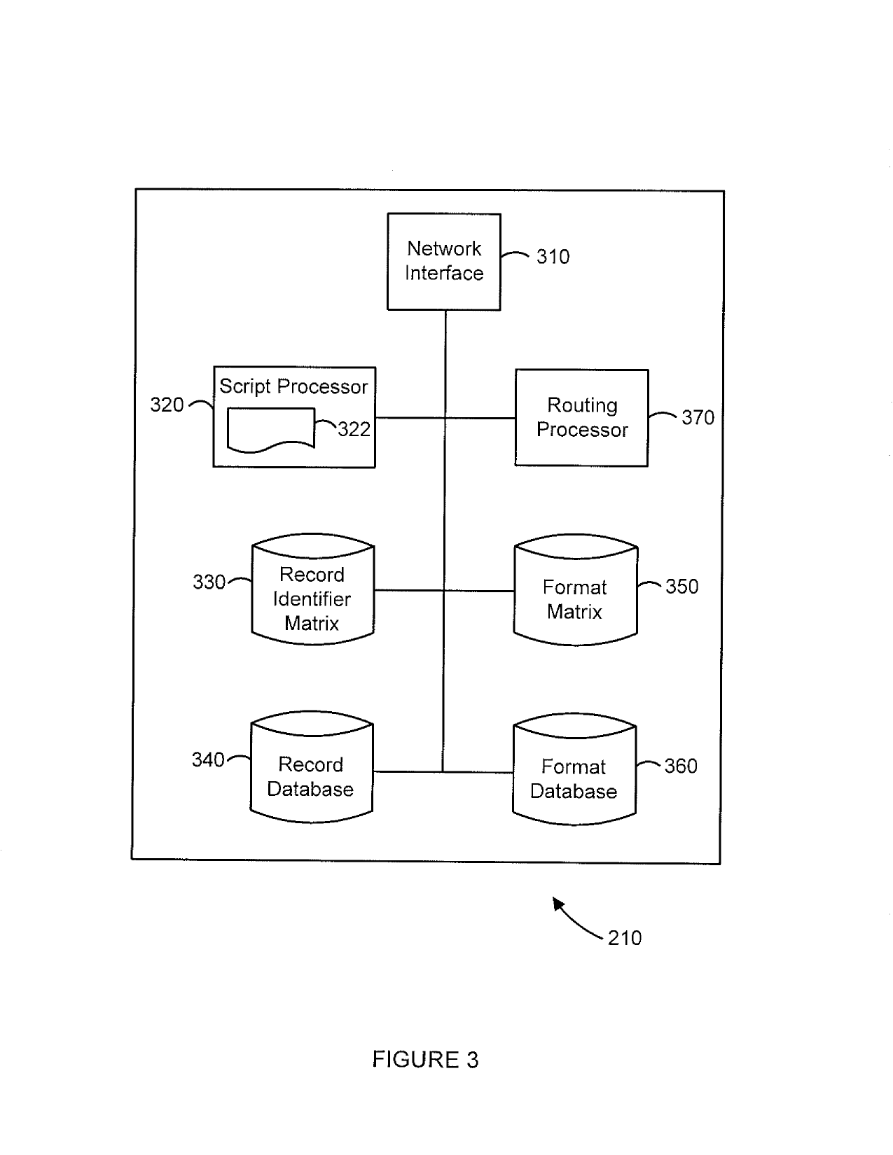

Referring now to FIG. 3, there is shown a block diagram of an electronic contact card system 210 in accordance with an example embodiment. The electronic contact card system 210 may include, at least, a network interface 310, a script processor 320, a record identifier matrix 330, a record database 340, a format matrix 350, a format database 360 and a routing processor 370. The script processor 320 may store, at least, a controller file 322.

The routing processor 370 may include, at least, a routing mechanism for automatically routing a dynamic URL address 150 to the electronic contact card system 210 for conversion into a specific resource used to access an electronic contact card. The routing processor 370 may execute programs instructions for operation of the electronic contact card system 210 and may be any type of processor, such as, for example, any type of general-purpose microprocessor or microcontroller, a digital signal processing (DSP) processor, an application-specific integrated circuit (ASIC), a programmable read-only memory (PROM), or any combination thereof.

The network interface 310 is for connecting the electronic contact card system 210 to the network 220 for communicating with one or more devices, for example, 230, 240. The network interface 310 may be a wired and/or wireless network interface that allows the system 210 to connect to the network 220 and communicate with one or more devices 230, 240.

The routing processor 370 operates to route dynamic URL addresses 150 to the script processor 320. The routing processor 370 may be initialized or activated by various means, such as, for example, on receipt of a request to generate an electronic contact card or when a dynamic URL address 150 is accessed via a web browser 232, 242 on a computing device 230, 240. The routing processor 370 may operate on every request to the electronic contact card system 210 for an electronic contact card. The routing processor 370 may convert request URLs (e.g. dynamic URL addresses 150) to script.

When the routing processor 370 is initialized for routing a dynamic URL address 150, various parameters associated with the dynamic URL address 150 may be provided to the electronic contact card system 210. Specifically, the network interface 310 may receive various parameters associated with the dynamic URL address 150, such as the record identifier 152 and the source value 154 as they form part of the dynamic URL address 150. These parameters may then be parsed from the dynamic URL address 150 by the script processor 320, and, provided to the controller file 322 located in the script processor 320.

The script processor 320 may execute program instructions for operation of the electronic contact card system 210 and may be any type of processor, such as, for example, any type of general-purpose microprocessor or microcontroller, a digital signal processing (DSP) processor, an application-specific integrated circuit (ASIC), a programmable read-only memory (PROM), or any combination thereof. The script processor 320 may operate to convert the dynamic URL 150 into a specific resource for accessing an electronic contact card using a controller file 322. The script processor 320 may be operable to parse the dynamic URL address 150 for parameters, such as the record identifier 152 and the source value 154, which may be used to generate the specific resource for accessing the electronic contact card. The specific resource may be a file that ends in “.vcf” and may be used to stream an electronic contact card formatted based on the source value 154 with contents based on the electronic contact card record identified using the record identifier 152.

The record database 340 is memory for storing and managing electronic contact card records, where each electronic contact card record is associated with one or more entities. Each electronic contact card record stores contact data for the associated entity. The record identifier matrix 330 associates each electronic contact card record with a record identifier used by electronic contact card system 210 to retrieve contents of a particular electronic contact card record to generate an electronic contact card.

The format database 360 is memory for storing and managing electronic contact card record formats. An electronic contact card format may be a template, data structure, rule, and so on defining the format for an electronic contact card. The format may be specific to an electronic contact book, source for the electronic contact card, recipient of the electronic contact card, and so on. The format may specify which content data to include in a particular electronic contact card, the layout of the electronic contact card and so on. The electronic contact card record may associate labels or descriptors for values of the content data. For example a label may be “First Name” and the value may be “Michael”. The labels or descriptors may identify various types of data of the contact data. The format matrix associates source identifiers with one or more electronic contact card formats.

The components of the electronic contact card system 10 may be configured to communicate with each other. For example, the record database 340 may be configured to communicate with the record identifier matrix 330, which may be configured to communicate with the network interface 310. Similarly, the format database 360 may be configured to communicate with the format matrix 350, which may be configured to communicate with the network interface 310.

In an example embodiment, each of the record identifier matrix 330, the record database 340, the format matrix 350, and the format database 360 may be configured to each independently communicate with the network interface 310. In a further example embodiment, each of the matrixes 330 and 350 and the databases 340 and 360 may be configured to communicate with the network interface 310 through the script processor 320.

In a further example embodiment, the record identifier matrix 330 and the record database 340 may be stored together as one database, and similarly, the format matrix 350 and the format database 360 may also be stored together as one database. In another example embodiment, the record identifier matrix 330, the record database 340, the format matrix 350, and the format database 360 may be stored on one database.

It will be understood by a person skilled in the art that the described configurations are only example embodiments and that alternative configurations may also be used to implement the electronic contact card system 210.

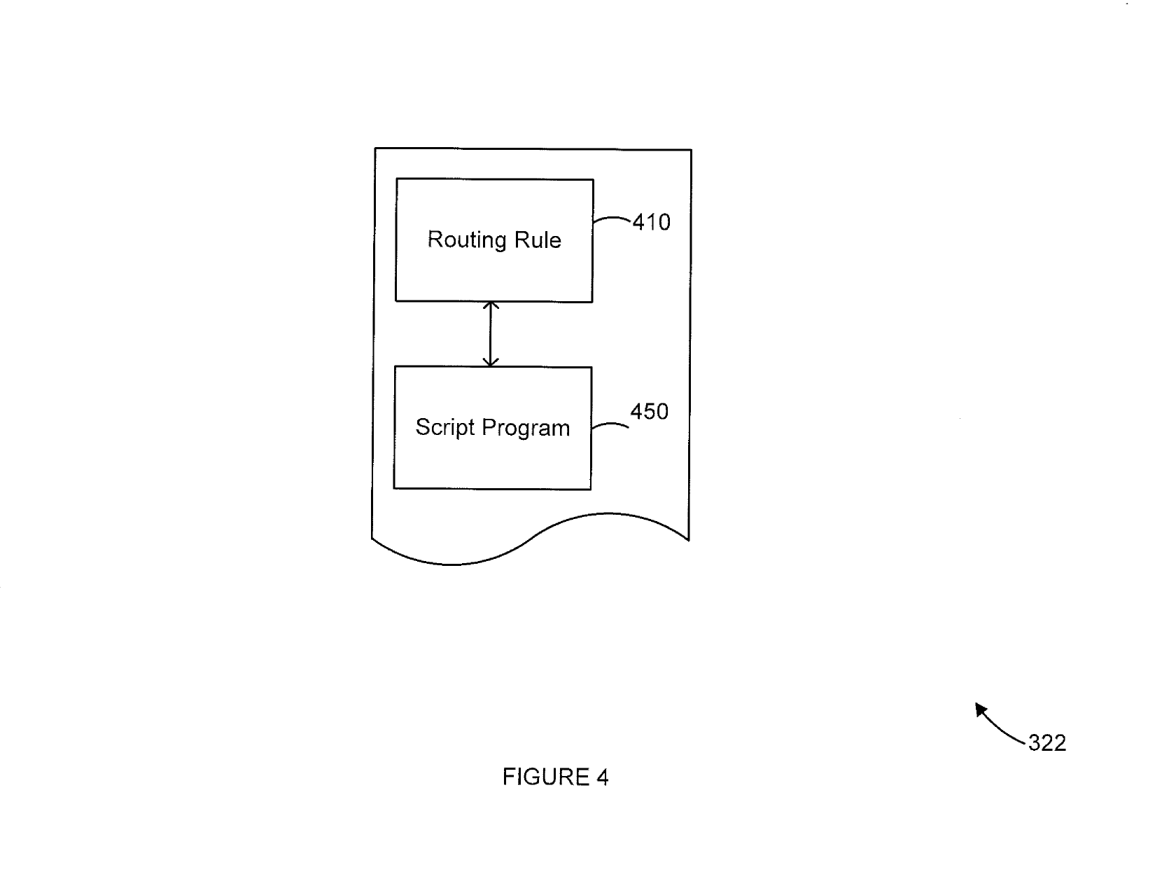

Referring now to FIG. 4, there is shown a block diagram of a controller file 322 in accordance with an example embodiment. Within the controller file 322, there is at least a routing rule 410 and a script program 450.

It will be understood by a person skilled in the art that the routing rule 410 and/or the script program 450 may be stored apart from the controller file 322 but still be accessible by the controller file.

When the routing processor 370 routes a dynamic URL address 150 of a web browser, such as browser 232 or 242, on a computing device, such as device 230 or 240, to the routing rule 410 in the controller file 322, the routing rule 410 may receive various parameters of the dynamic URL address 150 via the network interface 310. The routing rule 410 may operate to pass the dynamic URL address 150 including the parameters, such as the record identifier 152 and the source value 154, to the script program 450. The script program 450 may operate to generate a specific resource ending in “.vcf”, such as for example a static file URL address 110 or static file, by parsing the dynamic URL address 150 to extract the parameters, such as the record identifier 152 and source value 154. The resource may be a new URL address for accessing the electronic contact card, for example static URL address 110, which may be associated with the same electronic contact card and contents thereof that the dynamic URL address 150 is associated with as specified by the parameters. The new resource, such as URL address, may appear to web browser 232, 242 as a static URL address 110 which may be advantageous if the web browser 232, 242 is not compatible with dynamic URL addresses 150 for electronic contact cards, is optimized for static URL addresses 110 for electronic contact cards, and so on.

In an example embodiment, the above-described routing mechanism may be developed on Ruby on Rails™ web application framework, or other suitable web application frameworks. An example routing rule 410 may be as follows:
match ‘/cards(/:locale/:id).vcf’, :to=>“cards#vcarddirect”
   where the text inside the bracket represents variable values that are passed as parameters to the script program 450 for generating a new URL address ending in “.vcf”, such as for example a static file URL address 110. For example, “locale” may represent the source value 154 and “id” may represent the record identifier 152. It will be understood that other values may be passed by the routing rule 410, and that other routing rules may be used to implement the electronic contact card system 210.

For example, a dynamic URL address associated with an electronic contact card, such as the dynamic URL address 150, may be routed by a routing processor 370 from a web browser, such as web browser 232 or 242, of a computing device, such as device 230 or 240, to the system 210. As illustrated in FIG. 1, the dynamic URL address 150 may contain various parameters associated with records storing contents used to generate electronic contact cards, such as, for example, a record identifier 152 and a source value 154.

When the routing processor 370 operates to route a dynamic URL address 150 to the electronic contact card system 210, the routing rule 410 receives various parameters associated with the dynamic URL address 150 and passes these parameters to a script program 450. The script program 450 may be operable to parse the dynamic URL address 150 to extract the parameters therein. The script program 450 may then generate a specific resource for accessing an electronic contact card generated based on the parameters, such as the record identifier 152 and a source value 154. The specific resource may be used to access or stream the file for an electronic contact card that ends in “.vcf”. The specific resource may appears to computing devices and web browsers as a static file for an electronic contact card that ends in “.vcf”, such as a static file URL address 110, based on the received parameters. The new static URL address 110 may include various parameters, such as a file reference (“file”) 112, for associating the new static URL address with the electronic contact card. That is, the routing processor 370 and script program 450 may operate to parse a dynamic URL address 150 and generate a specific resource based on the parameters of the dynamic URL address 150. The specific resource may be a static URL or file for streaming an electronic contact card, such as a file that ends in “.vcf”. The electronic contact card is generated based on the parameters of the dynamic URL address 150.

When the specific resource for accessing the electronic contact card is generated using the parameters, the corresponding electronic contact card may also be generated. The electronic contact card may be generated based on the parameters of the dynamic URL address 150 that are associated with the record storing the contents for the electronic contact card, such as the record identifier 152 and the source value 154.

The content of the electronic contact card may include at least a portion of an electronic contact card record associated with the record identifier 152. The electronic contact card may be formatted based on the source value 154 or other parameters. The relevant electronic contact card record may be retrieved from the electronic contact card records based on the record identifier 152.

Referring back to FIG. 2, the relevant electronic contact card record may be retrieved based on the record identifier 152 by referring to the record identifier matrix 330. The record identifier matrix 330 may include, at least, a database for associating each of the electronic contact card records with a corresponding record identifier 152. The electronic contact card records are stored in the record database 340. Each of the plurality of electronic contact card records may include contact data associated with an entity, such as, for example, names, photo(s), credential(s), title(s), phone number(s), email address(es), links to website(s), links to social network profile(s), chat and instant message handle(s), photographs, audio clips, video clips, etc., associated with the entity, such as an individual, an organization, a business, and so on.

An appropriate format for the electronic contact card may be determined based on the source value 154 associated with the dynamic URL address 150. The appropriate format may be an electronic contact card format that is compatible with an electronic contact book, such as electronic contact book 234 or 244, associated with the computing device, 230 or 240 for example, from which the dynamic URL address 150 was routed. Examples of electronic contact books include Outlook™, Outlook Express™, Windows Live Mail™, Goldmine CRM™, ACT! By Sage™, Lotus Notes™, Mac Address Book™, Entourage™, and so on.

Referring back to FIG. 2, the appropriate format for the electronic contact card may be determined by the source value 154 by referring to the format matrix 350. The format matrix 350 may include, at least, a database for associating each electronic contact card format with at least one corresponding source value 154. It will be understood that more than one source value 154 may be associated with each of the electronic contact card formats. The electronic contact card formats may be stored in the format database 360. The formats may be defined by templates, parameters, data structures and so on.

The electronic contact card may be generated for at least a portion of the contact data in the electronic business record determined to be associated with the record identifier 152 using the record identifier matrix 330. The format for the electronic contact card may be a format from the electronic contact card formats in the format database 360 that is determined to be associated with the source value 154 using the format matrix 350. The electronic contact card may therefore be generated in a format that is compatible with the electronic contact books 234 and 244 of the associated computing devices 230 and 240, respectively.

When the specific resource for accessing the electronic contact card ending in “.vcf” 110 is activated, the electronic contact card associated with the file reference 112 may be streamed to the web browser 132 or 142 on the device 130 or 140, respectively, from which the dynamic URL address 150 was routed. The electronic contact card will be streamed to the web browser 132 or 142 in the format as determined from the source value 154 associated with the dynamic URL address 150 and to contain at least a portion of the contact data in the electronic contact card record determined to be associated with the record identifier 152 of the dynamic URL address 150.

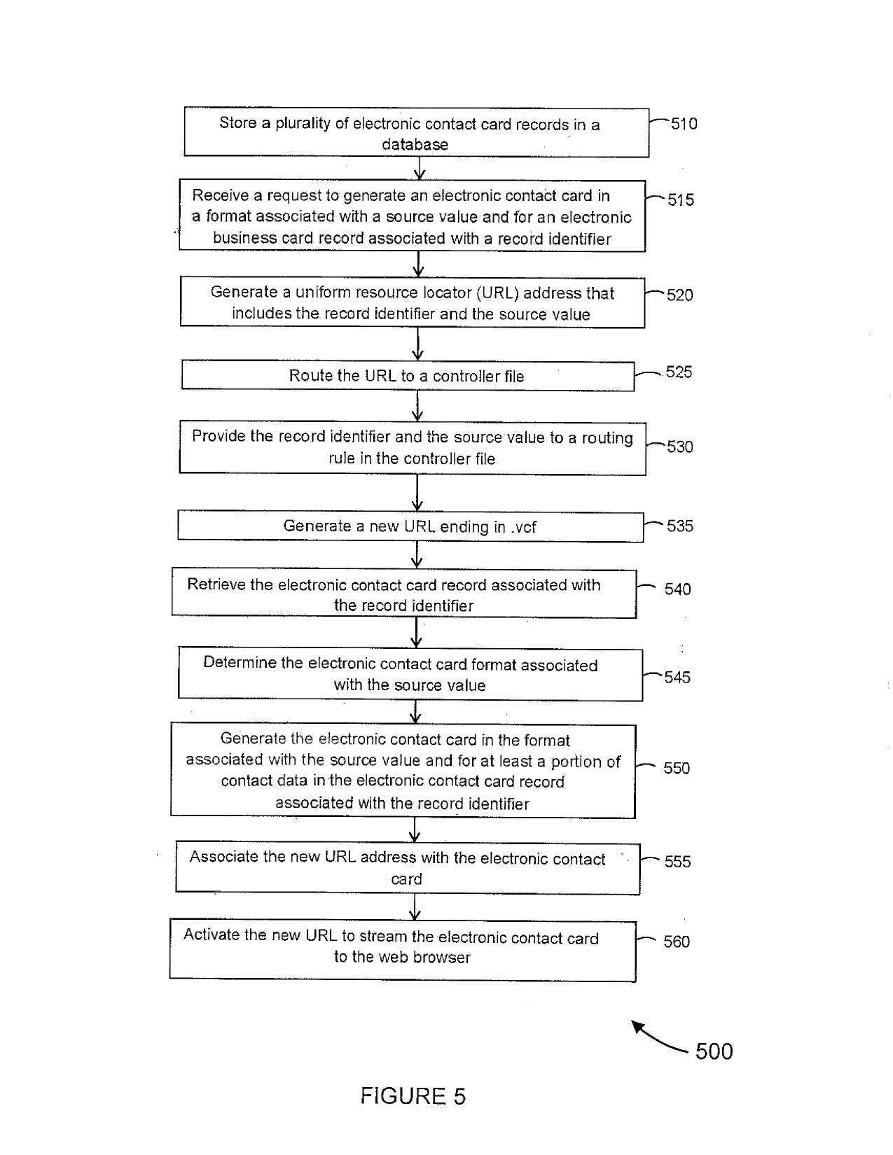

Reference is now made to FIG. 5, which is a flowchart diagram of a method 500 for providing an electronic contact card in accordance with an example embodiment.

Contact information associated with entities may be stored in a database. The contact information may be organized as electronic contact card records managed by the record database 340, such that contact information for a particular entity is organized into an electronic contact card record associated with the entity. The contact information may be stored as records in a database and may include, for example, names, photo(s), credential(s), title(s), phone number(s), email address(es), links to website(s), links to social network profile(s), chat and instant message handle(s), video clips, audio clips, photographs, images etc., associated with the entity. The contact information stored in electronic contact card records may be updated from time to time and the electronic contact card record identifies the updated contact information, as well as previous versions of the contact information in some embodiments.

At 510, electronic contact card records associated with one or more entities may be stored in a database. Each electronic contact card record may be associated with an entity and identified using a record identifier. In one example embodiment, the database may be located in the electronic contact card system 210. The database may be the record database 340. The record database 340 may be associated with the record identifier matrix 330 as each electronic contact card record may be associated with a record identifier.

At 515, electronic contact card system 210 may receive a request for generating an electronic contact card. In some embodiments, the request may include the source value 154 for determining a corresponding electronic contact card format and the record identifier 152 for retrieving a corresponding electronic contact card record storing contents for the electronic contact card. The electronic contact card system 210 may then retrieve the corresponding electronic contact card record from the record database 340.

At 520, a dynamic URL address 150 associated with the electronic contact card may then be generated, provided, received and so on. For example, the request may include the dynamic URL address 150. The dynamic URL address 150 may include various parameters, such as, for example the record identifier 152 and the source value 154. It will be understood by a person skilled in the art that a dynamic URL address 150 may be available without the request for generating an electronic contact card. The dynamic URL address 150 may, for example, be a web address or web link.

At 525, the dynamic URL address 150 associated with a dynamic electronic contact card may be routed to the controller file 322 stored on the script processor 320. The controller file 322 may include the routing rule 410 and the script program 450 for generating a specific resource for accessing the electronic contact card. In example embodiments, the dynamic URL address 150 may be routed by a routing processor 370 as part of a routing mechanism. In a further embodiment, the routing rule 410 may be part of the routing mechanism.

At 530, the routing rule 410 in the controller file 322 parses the dynamic URL address 150 to extract the parameters therein and passes the record identifier 152 and the source value 154 to the script program 450.

At 535, the script program 450 may generate specific resource for accessing the electronic contact card, such as a new URL address ending in “.vcf” 110 based on the record identifier 152 and the source value 154 associated with the dynamic URL address 150.

At 540, to generate an electronic contact card, the electronic contact card system 210 retrieves an electronic contact card record from the record database 340 determined to be associated with the record identifier 152 using the record identifier matrix 330.

At 545, the electronic contact card system 210 determines which electronic contact card format from the format database 360 is associated with the source value 154 based on the format matrix 350.

At 550, the electronic contact card system 210 generates the electronic contact card in the format associated with the source value 154 and using at least a portion of contact data in the electronic contact card record associated with the record identifier 152.

At 555, the specific resource for accessing the electronic contact card is associated with the electronic contact card via a link. For example if the specific resource is a static URL address 110 then it may be associated with the electronic contact card by, at least, a file reference 112 in the new static URL address 110.

At 560, the generated electronic contact card may be streamed to the web browser 232 or 242 on the device 230 or 240 respectively from which the dynamic URL address 150 was originally routed by activating the specific resource.

Some web browsers may only import electronic contact card files if they are static files stored on a server, where essentially, the URL for the static file must end in “.vcf”. That is, some web browsers may not be able to identify a dynamic URL as corresponding to an electronic contact card and may only identify specific electronic resources, such as a file or URL, ending in “.vcf” as corresponding to an electronic contact card. Some web services may generate electronic contact card files dynamically by providing a dynamic URL and may not be able to provide a static URL because the web service has to dynamically generate the electronic contact card on demand. For example, a web service may offer somewhat different versions of the content of an electronic contact card based on source or recipient such as the type of electronic contact book being used, specific contents, required text encoding and so on, and dynamically generates the electronic contact card based on the source.

The script processor 320 may be operable to parse a dynamic URL to identify parameters to determine the final format of the requested electronic contact card. The parameters may be a record identifier which may be a unique ID to determine whose card to generate based on data stored in a particular electronic contact card record, and a source value to determine the specific formatting of the electronic contact card. The script processor 320 may generate the specific resource for accessing the electronic contact card using the extracted parameters. Once the electronic contact card is generated and the specific resource activated, a command is sent to the web server (associated with electronic contact card system 210) to stream an electronic contact card file of type “.vcf” to the requested web browser. That stream may contains header information that help the web browser identify the file type, so the web browser knows how to handle it and knows that it is an electronic contact card.

Some web browsers implementations may have limitations where the web browser won't recognize the file type in the header information. The web browser may ignore the header information in the stream from the electronic contact card system 210, and may only pay attention to the file path itself. Therefore, if the file string for the electronic contact card (e.g. the dynamic URL) does not end in .vcf, then the web browser does not identify the file as electronic contact card. As a consequence, the user may be able to download the file, but the electronic contact card may not be automatically added to the electronic contact book.

The electronic contact card system 210 uses a web development framework to define a routing mechanism that converts dynamic URLs in a web browser to scripts that may appear to be static URLs or files ending in “.vcf”.

As an illustrative example, a dynamic URL https://server.com/cards/vcard?id=334&source=outlook may be routed to the script processor 320 and a controller file 322 along with two parameters record identifier (id=334) and source identifier (source=outlook).

The script processor 320 may be operable generate and forward a specific resource that ends in .vcf to a particular script program 450 using a routing rule, such as this example rule: match ‘/cards(/:locale/:id).vcf’, :to=>“cards#vcarddirect”

The text inside the brackets represents variable values which get passed as a parameter to the script program of the controller file 322. This technique may yield a static URL such as this example https://contactmonkey.com/cardslen/334.vcf

To the web browser, the result is that a dynamic URL is converted to look and act exactly like a static URL on a web server (electronic contact card system 210). Therefore, a user clicking the static URL link will receive the electronic contact card and can add it to their electronic contact book right from the web browser.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A computer implemented method for providing an electronic contact card wherein the computer comprises a processor and a memory coupled to the processor and configured to store instructions executable by the processor to perform the method comprising:
storing a plurality of electronic contact card records, wherein each electronic contact card record comprises contact data associated with an entity;
receiving a request to generate an electronic contact card from a computing device, wherein the request comprises a dynamic uniform resource locator, wherein the dynamic uniform resource locator comprises a record identifier corresponding to an electronic contact card record and a source value corresponding to an electronic contact card format compatible with the computing device;
routing a dynamic uniform resource locator to a controller file;
parsing the dynamic uniform resource locator to provide the record identifier and the source value as parameters to a routing rule of the controller file; and
generating, using the processor, a static resource using a script program of the controller file, wherein the routing rule passes the record identifier, the source value, and a file suffix for the static resource to the script program to generate the static resource, wherein the static resource is for accessing the electronic contact card, wherein the static resource is a static file ending with the file suffix, wherein the file suffix corresponds to a file format recognizable by the computing device for accessing the electronic contact card, and wherein the electronic contact card comprises at least a portion of the contact data of the electronic contact card record identified by the record identifier and is in the electronic contact card format corresponding to the source value.

2. The method of claim 1 wherein the static resource may be activated to stream the electronic contact card to the web browser.

3. The method of claim 1 wherein receiving the request to generate the electronic contact card; further comprises:
generating the uniform resource locator using the record identifier and the source value.

4. The method of claim 1 further comprising:
retrieving the corresponding electronic contact card record using the record identifier;
using the source value to determine the electronic contact card format, wherein the format is compatible with an electronic contact book;
generating the electronic contact card in the format compatible with the electronic contact book, wherein the electronic contact card comprises the portion of contact data of the corresponding electronic business record; and
associating the static resource with the electronic contact card by including a file reference for the electronic contact card as part of the static resource.

5. A computer system for providing an electronic contact card comprising one or more processors and memory configured to provide:
a record database comprising a plurality of electronic contact card records, wherein each electronic contact card record comprises contact data associated with an entity;
a format database for storing a plurality of electronic contact card formats compatible with a corresponding plurality of electronic contact books;
a record identifier matrix for associating each of the plurality of electronic contact card records with a corresponding record identifier;
a format matrix for associating each of the electronic contact card formats with a corresponding source value;
a script processor comprising a controller file, wherein the controller file comprises at least a routing rule and a script program;
a routing mechanism for receiving a request to generate an electronic contact card from a computing device, wherein the request comprises a dynamic uniform resource locator, wherein the dynamic uniform resource locator comprises a record identifier corresponding to an electronic contact card record and a source value corresponding to an electronic contact card format compatible with the computing device and routing the uniform resource locator to the controller file;
wherein the routing rule receives the source value, the record identifier, and a file suffix for a static resource and passes the source value, the record identifier, and the file suffix to the script program for generating the static resource, wherein the static resource is for accessing the electronic contact card, wherein the static resource is a static file ending with the file suffix, wherein the file suffix corresponds to a file format recognizable by the computing device for accessing the electronic contact card, and wherein the electronic contact card comprises at least a portion of the contact data of the electronic contact card record and is in the electronic contact card format corresponding to the source value.

6. The system of claim 5 wherein the static resource may be activated to stream the electronic contact card to the web browser.

7. The system of claim 5 wherein the routing mechanism is further configured to generate the dynamic uniform resource locator using the record identifier and the source value.

8. The system of claim 5 wherein the script processor is further configured to:
retrieve the corresponding electronic contact card record using the record identifier;
use the source value to determine the electronic contact card format, wherein the format is compatible with an electronic contact book;
generate the electronic contact card in the format compatible with the electronic contact book, wherein the electronic contact card comprises the portion of contact data of the corresponding electronic business record; and
associate the static resource with the electronic contact card by including a file reference for the electronic contact card as part of the static resource.

9. A computer-readable storage medium storing one or more sequences of instructions which, when executed by one or more processors, causes the one or more processors to perform a method for providing an electronic contact card, the method comprising:
storing a plurality of electronic contact card records, wherein each electronic contact card record comprises contact data associated with an entity;
receiving a request to generate an electronic contact card from a computing device, wherein the request comprises a dynamic uniform resource locator, wherein the dynamic uniform resource locator comprises a record identifier corresponding to an electronic contact card record and a source value corresponding to an electronic contact card format compatible with the computing device;
routing a dynamic uniform resource locator to a controller;
parsing the dynamic uniform resource locator to provide the record identifier and the source value as parameters to a routing rule of the controller file; and
generating a static resource using a script program of the controller file, wherein the routing rule passes the record identifier, the source value, and a file suffix for the static resource to the script program to generate the static resource, wherein the static resource is for accessing the electronic contact card, wherein the static resource is a static file ending with the file suffix, wherein the file suffix corresponds to a file format recognizable by the computing device for accessing the electronic contact card, and wherein the electronic contact card comprises at least a portion of the contact data of the electronic contact card record identified by the record identifier and is in the electronic contact card format corresponding to the source value.

10. The computer readable medium of claim 9, wherein the static resource may be activated to stream the electronic contact card to the web browser.

11. The computer readable medium of claim 9, wherein receiving the request to generate the electronic contact card further comprises:
generating the uniform resource locator using the record identifier and the source value.

12. The computer readable medium of claim 9, wherein the method further comprises:
retrieving the corresponding electronic contact card record using the record identifier;
using the source value to determine the electronic contact card format, wherein the format is compatible with an electronic contact book;
generating the electronic contact card in the format compatible with the electronic contact book, wherein the electronic contact card comprises the portion of contact data of the corresponding electronic business record; and
associating the static resource with the electronic contact card by including a file reference for the electronic contact card as part of the static resource.
